(19) United States
(12) Patent Application Publication
(10) Pub. No.: US 2013/0346188 A1
(43) Pub. Date: Dec. 26, 2013

(54) Estimating Costs of behavioral Targeting

(71) Applicants: Martin B. Scholz, San Francisco, CA (US); Shyam Sundar Rajaram, San Francisco, CA (US); Rajan Lukose, Oakland, CA (US)

(72) Inventors: Martin B. Scholz, San Francisco, CA (US); Shyam Sundar Rajaram, San Francisco, CA (US); Rajan Lukose, Oakland, CA (US)

(21) Appl. No.: 14/003,126

(22) PCT Filed: Mar. 15, 2011
(86) PCT No.: PCT/US11/28486

§ 371 Date: Sep. 4, 2013

(51) Int. Cl. G06Q 30/02

(52) U.S. Cl. CPC G06Q 30/0244
USPC 705/14.43

(57) ABSTRACT

Systems (490), methods (100, 200), and computer-readable and executable instructions (324, 424) are provided for estimating costs of behavioral targeting. Estimating costs of behavioral targeting can include scoring a topic with a behavioral targeting model (101, 201). Estimating costs of behavioral targeting can also include obtaining a plurality of data items including geographic location information (102, 202). Estimating costs of behavioral targeting can also include detecting (104, 204) and scoring (209) a sentiment from filtered data items regarding a topic within a region (104, 204). Estimating costs of behavioral targeting can include computing a penalty score for the topic in the region in response to the scored sentiment exceeding a threshold (213), (106, 206). Estimating costs of behavioral targeting can include adjusting the topic score in the region according to the penalty score (108, 208). Furthermore, estimating costs of behavioral targeting can include taking an action with respect to advertising based on the adjusted topic score (110, 210).

### BACKGROUND

Behavioral targeting is a useful tool for advertisers in the information age. However, the techniques used in behavioral targeting can have the tendency to offend a user when his or her preferences about a topic are misestimated. For example, directing promotions to a user of his or her rival sports team would be likely to offend the user. The costs of misestimating a user's preferences may vary according to topic and the region in which he or she is.

### BRIEF DESCRIPTION OF THE DRAWINGS

FIG. 1 is a flow chart illustrating an example of a method for estimating costs of behavioral targeting according to the present disclosure.

FIG. 2 is a flow chart illustrating an example of a method for estimating costs of behavioral targeting according to the present disclosure.

FIG. 3 illustrates a block diagram of an example of a computer-readable medium in communication with processing resources for estimating costs of behavioral targeting according to the present disclosure.

FIG. 4 illustrates a block diagram of an example of a computing system for estimating costs of behavioral targeting according to the present disclosure.

### DETAILED DESCRIPTION

Examples of the present disclosure can include methods, systems, and computer-readable and executable instructions and/or logic. An example method for estimating costs of behavioral targeting can include scoring a topic with a behavioral targeting model, obtaining a plurality of data items including geographic location information, detecting and scoring a sentiment from filtered data items regarding a topic within a region, computing a penalty score for the topic in the region in response to the scored sentiment exceeding a threshold, adjusting the topic score in the region according to the penalty score, and taking an action with respect to advertising based on the adjusted topic score.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

Successful advertising has been said to rely on showing the right person the right message at the right time. Because casting a broad advertising net is often prohibitively expensive, advertisers look for methods to focus advertising campaigns on those who may be most likely to have an interest in the content of the advertising. One such method is behavioral targeting.

Behavioral targeting is a technique used by online publishers, marketers, advertisers, and others to increase the effectiveness of their advertising campaigns. The idea behind behavioral targeting is that by better understanding a user's interests or preferences, advertising or other content can be more directly aimed at that user. A user's interests or preferences are estimated by collecting data regarding a number of things, for example, a user's web-browsing behavior, content of the user's electronic messages, metadata associated with that content and/or searches the user has made. Using this data, it is believed, helps owners and advertisers display content to a user that is relevant to the user's individual interests or preferences. For example, a user that frequents websites that offer camping products may be provided with advertising about a newly-released model of hiking boot. As social media websites have gained popularity, behavioral targeting has accordingly been applied to them.

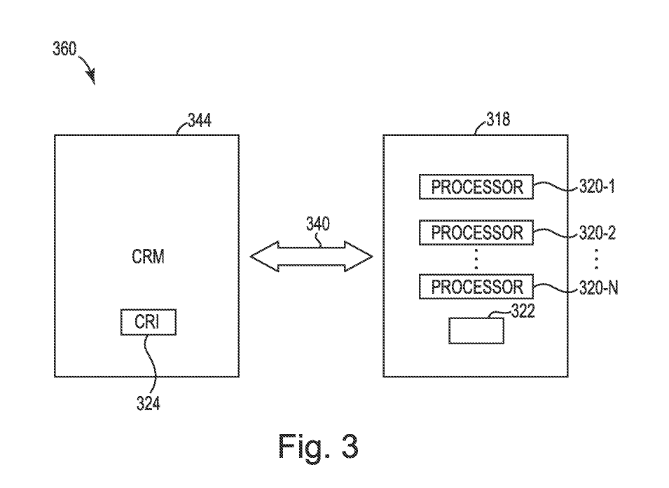

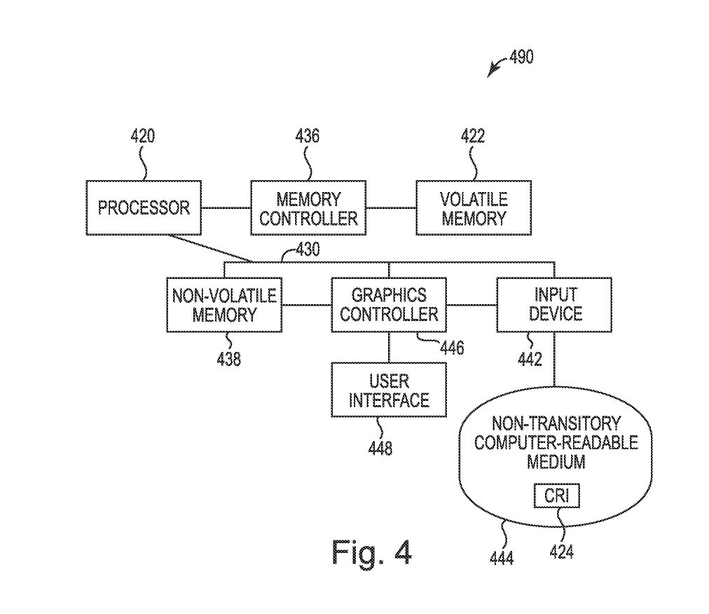

The figures herein follow a numbering convention in which the first digit or digits correspond to the drawing figure number and the remaining digits identify an element or component in the drawing. Similar elements or components between different figures can be identified by the use of similar digits. For example, 324 can reference element “24” in FIG. 3, and a similar element can be referenced as 424 in FIG. 4. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

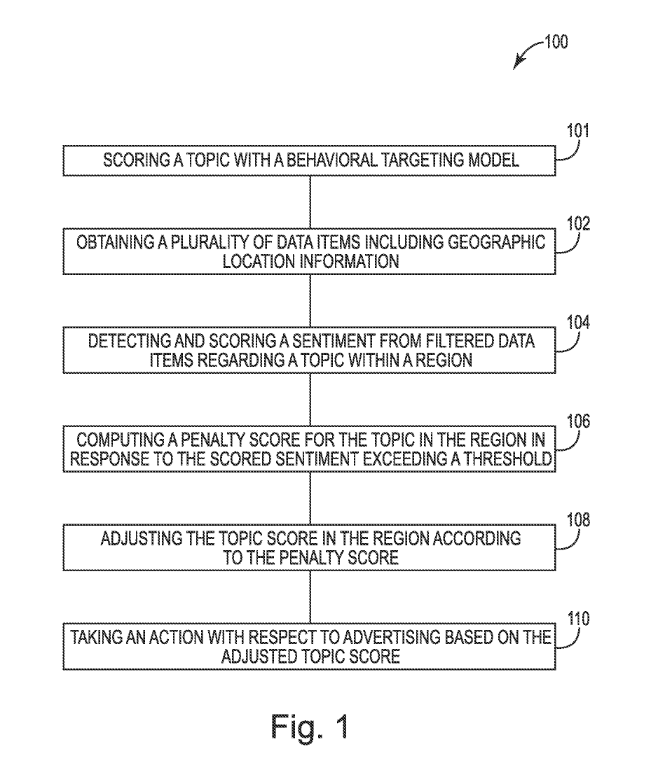

FIG. 1 is a flow chart illustrating an example of a method 100 for estimating costs of behavioral targeting according to the present disclosure. At 101, method 100 includes scoring a topic with a behavioral targeting model. As previously described, behavioral targeting can include a number of techniques used by online publishers, marketers, advertisers, and/or others to increase the effectiveness of their advertising campaigns. By better understanding a user's interests or preferences, advertising and/or other content can be more directly aimed at that user. A user's interests or preferences are estimated, for example, by collecting data regarding a number of things (e.g., a user's web-browsing behavior, content of the user's electronic messages, metadata associated with that content and/or searches the user has made, among other things). Scoring a topic with a behavioral targeting model can include, for example, determining a numeric score that can, for example, reflect a probability of success in advertising regarding a topic. Topic, as used herein, can refer to, for example, a sports team, a company, a political affiliation, a religious affiliation, a product, a product line, and/or any other topic to which a behavioral targeting model can be applied. Scoring a topic with a behavioral targeting model can include, for example, monitoring past user web browsing behavior, a given advertisement's relevance to the user, a given advertisement's relevance to a given webpage, popularity of a product or service, and/or location of the user, among other concerns.

At 102, a plurality of data items, including geographic location information, are obtained. As used herein, data items can take many forms. The data items can include, for example, a “tweet” made on Twitter®, a communication made on Facebook® or any other social media, a text message, a telephone call, an electronic mail message, a voicemail message, an answering machine message, or any other form of electronic message. In an example, a user “tweets” a comment regarding his or her interest in a topic.

A “tweet” can include, for example, a message or posting to the Twitter® website that includes information about the user. This information can include, for example, what the user is doing, watching, thinking, or anything else that can be communicated via the website. Communications made via Facebook® or any other social media can include the divulgence of the same or similar information related to the user as sent in a “tweet”. Outgoing messages sent via, for example, a text message, a telephone call, an electronic mail message, a voicemail message, an answering machine message, or other electronic message form can also include a similar divulgence of information related to the user as sent in a “tweet.” The tweets can be directly retrieved from Twitter® using their search application programming interface (API) without needing to examine all tweets.

The data items can be accompanied by geographic location information. Geographic location information, e.g., the location of the user, can be used to filter the data items by topic. Geographic location information can be determined by monitoring the user's IP address, monitoring cellular towers, monitoring, for example, the content of a social media message, monitoring the content of a text message, and/or monitoring global tracking on portable devices, among others.

At 104, a sentiment is detected and scored from filtered data items regarding a topic within a region. Region, as used herein, refers to a geographic region. Region can be defined in many ways, including, for example, city, state, zip code, area code, street, subdivision, structure wing, neighborhood, borough, township, range of latitude and longitude, range of streets, or any other geographic denotation. Region, as used herein, can be adjusted to respond to, for example, demographic changes and population changes. Region, as used herein, can also be adjusted to respond to governmental regulations and/or rulings, for example, those at municipal, local, state, and national levels. If, for example, a city annexes a neighboring suburb, region, as used herein, can be adjusted to respond to that change.

Topic, as used herein, can refer to, for example, a sports team, a company, a political affiliation, a religious affiliation, a product, a product line, or any other topic about which users can have a sentiment. Sentiment, as used herein, can, for example, refer to a user's opinion, like or dislike, attitude, or other feelings regarding a given topic. Detecting and scoring a sentiment from the filtered data items regarding a topic within a region can include, for example, analyzing the content of each of the data items, analyzing metadata associated with the data items, and others. For example, a “tweet” can be labeled with a number of hashtags. Hashtags can be used both to filter the data items by topic, as well as to detect a sentiment for the topic. To illustrate, tweets which include the hashtag “#SFGiants [symbol] ” can indicate a topic—the San Fransisco Giants baseball team, as well as a positive sentiment about that topic.

Data items obtained at 102 can be filtered data items that contain information regarding a desired topic within a region. Data items obtained at 102 can be unfiltered data items. Although not shown in FIG. 1, unfiltered data items obtained at 102 can be filtered, for example, by a topic and/or a region in accordance with one or more embodiments of the present disclosure. For example, a number of tweets can be filtered by a topic and a region. A number of data items may not contain information regarding a desired topic. Those that may not be relevant, because, for example, they do not contain information regarding a desired topic, can be disregarded. Furthermore, a number of data items can relate to a desired topic, but do not indicate a sentiment regarding that topic. Those data items, too, can be disregarded. For example, it can be that a large number of tweets yield a smaller number of useful tweets for sentiment detection. Further, if a small number of data items contain sentiment information on a desired topic, the confidence associated with the sentiment detected from those data items can be low. Accordingly, a larger number of data items indicating sentiment can yield a greater confidence associated with the sentiment detected from those data items.

Sentiment can be detected, for example, through the use of a sentiment dictionary. A sentiment dictionary can contain a list of terms as they can be used in an electronic message, coupled with the sentiment that the various terms indicate. For example, a Facebook® post: “Arrested Development LOL!” can be interpreted, through the use of sentiment dictionary, to indicate positive sentiment for the television show Arrested Development. The sentiment dictionary, as used herein, can be adjusted to respond to immediate as well as long-term changes in sentiment. The sentiment dictionary can also take many forms. Indeed, a sentiment dictionary can be a regional sentiment dictionary—as different regions can indicate sentiment differently—or a general sentiment dictionary, which can detect sentiment on a global or large-scale level.

Sentiment can also be detected through analysis of metadata associated with data items. Metadata such as a star tag used in a social media message can indicate a user's sentiment regarding the topic to which he or she is referring. For example, if a user enters “#Vikings winning by 14 points!*10” he or she is indicating a high degree of positive sentiment in the Minnesota Vikings football team.

Scoring sentiment within a region can include analysis of the data items within a region that indicate a sentiment towards a topic of interest. Within a region, data items indicating both positive and negative sentiment for a topic can be compiled and mapped to yield a regional sentiment score indicating the level of sentiment for the topic within the region. Depending on how region is defined, there may be gaps between regions. Here, techniques such as interpolation can be used to fill and smooth the gaps between regions. In scoring a region's sentiment for a topic, attention can be paid to other factors. For one, timing can be a relevant factor. To illustrate, sentiment in San Francisco for the Giants baseball team may be extremely high the day they are in a World Series game, but may be markedly lower even seconds after a game-losing base running error. This type of sentiment information could be obtained from the data items themselves, or from other sources, such as regional, local, or national news media.

At 106, a penalty score is computed for the topic in the region(s) where the sentiment score exceeds a threshold. For example, a penalty score can be computed for regions where the sentiment score is below average. Average, as used herein, can refer to a global average, an average of a plurality of regions, a national average, and the like. Where computing a penalty score is applicable, a lower sentiment score yields a higher penalty score. Regions having a high penalty score indicate a lessened sentiment and therefore a greater risk of offending a user by misestimating the user's preferences. Penalty score, as used herein, can be a reflection of the likely amount of users having positive sentiment for a topic in a region. Where sentiment is low, penalty score is accordingly high. A region having a high penalty score is estimated to be generally low in sentiment. Accordingly, directing advertising for the topic in those regions can be inadvisable.

At 108, the topic score for a region is adjusted according to the penalty score. The topic score, obtained from, for example, a method of behavioral analysis, is adjusted by the penalty score yielding an adjusted topic score. The adjusted topic score can reflect the cost of misestimating a user's preferences regarding a topic within a region. For example, in regions where the adjusted topic score for a topic is low, the corresponding penalty score can be high, and the cost of misestimating a user's preferences regarding that topic can be high. To illustrate, a region having a high penalty score for a topic can be likely to have few users within it having high sentiment for the topic. Accordingly, the scored sentiment can be reduced, in some cases, significantly if the penalty score is sufficiently high. Determining an adjusted topic score allows for reasoned decisions regarding advertising placement and can optionally minimize the reliance on user-specific models. Determining an adjusted topic score can allow for less granularity and more prudent estimation while potentially saving costs.

At 110, an action is taken with respect to advertising based on the adjusted topic score. In an example, the action is deciding whether or not to place an advertisement. In another example, the action is making a recommendation regarding whether or not to place an advertisement. The risk of offending a person in a given region by placing advertising regarding a given topic can be minimal if the person is in an area with high sentiment regarding that topic. This region can have a low, or nonexistent, penalty score. To illustrate, a user living in San Francisco—a region likely to have a relatively high adjusted topic score regarding the San Francisco Giants—a decision could be made to direct advertising for Giants merchandise to that user. Directing advertising for Giants merchandise may be prudent in this example because sentiment for the Giants in the region (San Francisco) is high. Accordingly, the risk of offending a user by showing them Giants merchandise is low.

Furthermore, users with low sentiment for a topic in a region of high sentiment for the topic are less likely to be offended by advertisements regarding the topic than users with low sentiment for the topic in regions with low sentiment for the topic. For example, a Los Angeles Dodger fan living in San Francisco may not be offended by advertisements regarding Giants merchandise perhaps because it is understandable to the user why he may be directed advertisements regarding Giants merchandise. The user may find it understandable because he lives in San Francisco: an area that the user can accept as likely to have high sentiment for the Giants.

Conversely, directing advertising regarding a given topic in a region bearing low sentiment regarding that topic can be imprudent. The risk of offending a person in a given region by placing advertising regarding a given topic can be enhanced if the person is in an area with low sentiment regarding that topic. This type of region can have a higher penalty score. To illustrate, a user living in San Francisco, a region likely to have a relatively low adjusted topic score regarding the Los Angeles Dodgers, a decision could be made not to direct advertising for Dodgers merchandise to that user. Not directing advertising to a user in a region with a low adjusted topic score about a topic can be prudent because the risk of offending a user by advertising the topic can be high. Offending a user or users is likely to have deleterious effects on the success of the advertising campaign.

Taking an action with respect to advertising can also include weighing the adjusted topic score relative to data specific to a user indicating that the sentiment of the user conflicts with the adjusted topic score. For example, a user in a region with high sentiment regarding a topic can still be offended by advertising regarding that topic. Here, if the user has supplied any data items indicating his low sentiment for the topic, the sentiment indicated in those data items could be weighed against the high adjusted topic score of the region. User-specific data items exhibiting sufficiently high weight could, for example, override an action with respect to advertising recommended by the adjusted topic score of the region. For example, an avid Dodger fan can live in San Francisco. If the fan, through data items obtained at 102, has indicated sufficiently low sentiment for the Giants and/or sufficiently high sentiment for the Dodgers, this user-specific data can override the general notion that the risk of offending a San Franciscan by presenting them with advertisements for the Giants is low.

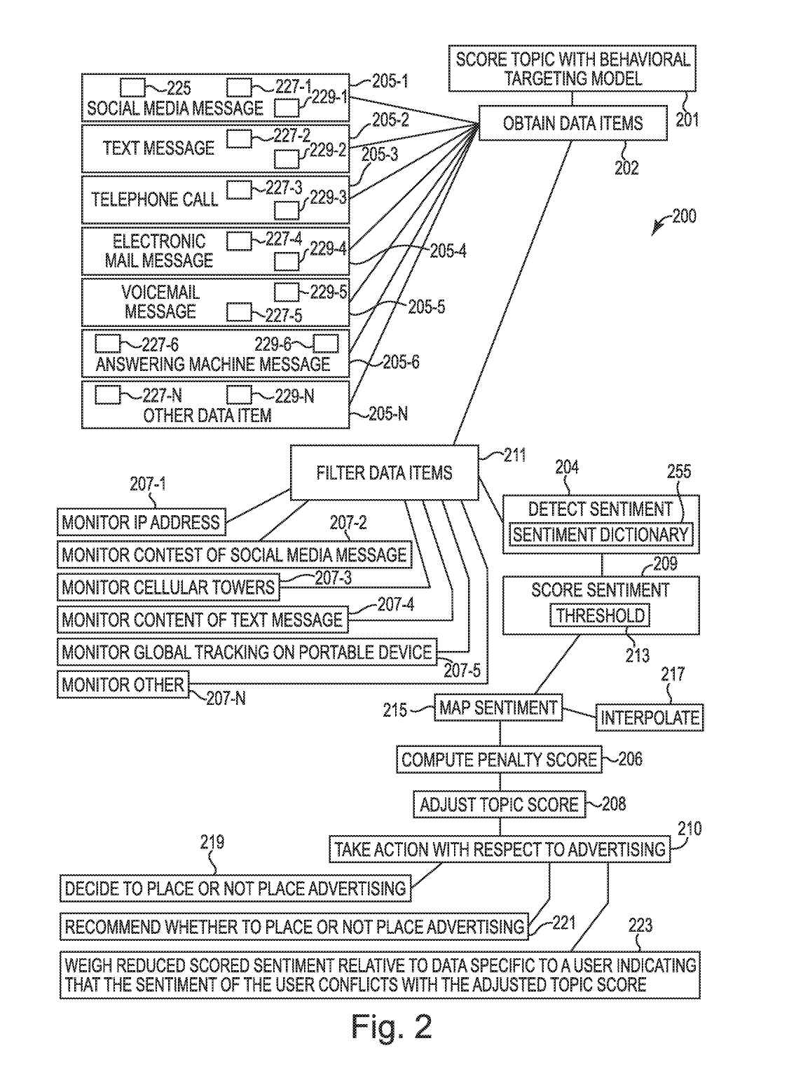

FIG. 2 is a flow chart illustrating an example of a method 200 for estimating costs of behavioral targeting according to the present disclosure. At 201, method 200 includes scoring a topic with a behavioral targeting model. Scoring a topic with a behavioral targeting model can be carried out, for example, in an analogous manner to that discussed in connection with block 101 of FIG. 1. At 202, a plurality of data items 205-1, 205-2, 205-3, 205-4, 205-5, 205-6, 205-N, including geographic location information 227-1, 227-2, 227-3, 227-4, 227-5, 227-6, 227-N, are obtained. As used herein, data items can take many forms. The data items can include, for example, a “tweet” made on Twitter®, a communication made on Facebook® or any other social media 205-1, a text message 205-2, a telephone call 205-3, an electronic mail message 205-4, a voicemail message 205-5, an answering machine message 205-6, or any other form of electronic message 205-N. In an example, a user “tweets” a comment regarding his or her interest in a topic.

A “tweet” can include, for example, a message or posting to the Twitter® website that includes information about the user. This information can include, for example, what the user is doing, watching, thinking, or anything else that can be communicated via the website. Communications made via Facebook® or any other social media can include the divulgence of the same or similar information related to the user as sent in a “tweet”. Outgoing messages sent via, for example, a text message 205-2, a telephone call 205-3, an electronic mail message 205-4, a voicemail message 205-5, an answering machine message 205-6, or other electronic message form 205-N can also include a similar divulgence of information related to the user as sent in a “tweet.” The tweets can be directly retrieved from Twitter® using their search application programming interface (API) without needing to examine all tweets.

The data items can be accompanied by geographic location information 227-1, 227-2 . . . 227-N. Geographic location information, e.g., the location of the user, can be used to filter the data items by topic 211. Geographic location information 227-1, 227-2 . . . 227-N can be determined by monitoring the user's IP address 207-1, monitoring cellular towers 207-3, monitoring, for example, the content of a social media message 207-2, monitoring the content of a text message 207-4, and/or monitoring global tracking on portable devices 207-5, among others 207-N.

At 204, a sentiment is detected, and is scored at 209, from filtered data items 205-1, 205-2 . . . 205-N regarding a topic within a region. Region, as used herein, refers to a geographic region. Region can be defined in many ways, including, for example, city, state, zip code, area code, street, subdivision, structure wing, neighborhood, borough, township, range of latitude and longitude, range of streets, or any other geographic denotation. Region, as used herein, can be adjusted to respond to, for example, demographic changes and population changes. Region, as used herein, can also be adjusted to respond to governmental regulations and/or rulings, for example, those at municipal, local, state, and national levels. If, for example, a city annexes a neighboring suburb, region, as used herein, can be adjusted to respond to that change.

Topic, as used herein, can refer to, for example, a sports team, a company, a political affiliation, a religious affiliation, a product, a product line, or any other topic about which users can have a sentiment. Sentiment, as used herein, can, for example, refer to a user's opinion, like or dislike, attitude, or other feelings regarding a given topic. Detecting and scoring a sentiment from the filtered data items regarding a topic within a region can include, for example, analyzing the content of each of the data items 205-1, 205-2 . . . 205-N, analyzing metadata (e.g., 229-1, 229-2, 229-3, 229-4, 229-5, 229-6, 229-N) associated with the data items, and others. For example, a “tweet” can be labeled with a number of hashtags 225. Hashtags can be used both to filter 211 the data items 205-1, 205-2 . . . 205-N by topic, as well as to detect a sentiment 204 for the topic. To illustrate, tweets which include the hashtag “#SFGiants [symbol] ” can indicate a topic—the San Fransisco Giants baseball team, as well as a positive sentiment about that topic.

A number of data items may not contain information regarding a desired topic. Those that may not be relevant, because, for example, they do not contain information regarding a desired topic, can be disregarded. Furthermore, a number of data items can relate to a desired topic, but do not indicate a sentiment regarding that topic. Those data items, too, can be disregarded. For example, it can be that a large number of tweets yields a smaller number of useful tweets for sentiment detection, in a manner analogous to that discussed in connection with the method of FIG. 1.

Sentiment can be detected, for example, through the use of a sentiment dictionary 255. A sentiment dictionary can contain a list of terms as they can be used in an electronic message, coupled with the sentiment that the various terms indicate. For example, a Facebook® post: “Arrested Development LOL!” can be interpreted, through the use of sentiment dictionary 255, to indicate positive sentiment for the television show Arrested Development. The sentiment dictionary 255, as used herein, can be adjusted to respond to immediate as well as long-term changes in sentiment. The sentiment dictionary 255 can also take many forms. Indeed, sentiment dictionary 255 can be a regional sentiment dictionary—as different regions can indicate sentiment differently—or a general sentiment dictionary, which can detect sentiment on a global or large-scale level.

Sentiment can also be detected through analysis of metadata 229-1, 229-2 . . . 229-N associated with data items. Metadata such as a star tag used in a social media message can indicate a user's sentiment regarding the topic to which he or she is referring. For example, if a user enters “#Vikings winning by 14 points!*10,” he or she is indicating a high degree of positive sentiment in the Minnesota Vikings football team.

Scoring sentiment 209 within a region can include analysis of the data items 205-1, 205-2 . . . 205-N within a region that indicate a sentiment towards a topic of interest. Within a region, data items 205-1, 205-2 . . . 205-N indicating both positive and negative sentiment for a topic can be compiled and mapped 215 to yield a regional sentiment score indicating the level of sentiment for the topic within the region. Depending on how region is defined, there may be gaps between regions. Here, techniques such as interpolation 217 can be used to fill and smooth the gaps between regions. In scoring a region's sentiment for a topic, attention can be paid to other factors. For one, timing can be a relevant factor. To illustrate, sentiment in San Francisco for the Giants baseball team can be extremely high the day they are in a World Series game, but can be markedly lower even seconds after a game-losing base running error. This type of sentiment information could be obtained from the data items 205-1, 205-2 . . . 205-N themselves, or from other sources, such as regional, local, or national news media.

At 206, a penalty score is computed for the topic in the region(s) where the sentiment score exceeds a threshold 213. For example, a penalty score could be computed for regions where the sentiment score is below average. Average, as used herein, can refer to a global average, an average of a plurality of regions, a national average, and the like. Where computing a penalty score is applicable, a lower sentiment score yields a higher penalty score. Regions having a high penalty score indicate a lessened sentiment and therefore a greater risk of offending a user by misestimating the user's preferences. Penalty score, as used herein, can be a reflection of the likely amount of users having positive sentiment for a topic in a region. Where sentiment is low, penalty score is accordingly high. A region having a high penalty score is estimated to be generally low in sentiment. Accordingly, directing advertising for the topic in those regions can be inadvisable.

At 208, the topic score for a region is adjusted according to the penalty score. The topic score, obtained from behavioral analysis, as previously discussed, is adjusted according to the penalty score yielding an adjusted topic score. The adjusted topic score can reflect the cost of misestimating a user's preferences regarding a topic within a region. For example, in regions where the adjusted topic score for a topic is low, the corresponding penalty score can be high, and the cost of misestimating a user's preferences regarding that topic can be high. To illustrate, a region having a high penalty score for a topic can be likely to have few users within it having high sentiment for the topic. Accordingly, the scored sentiment can be reduced, in some cases, significantly if the penalty score is sufficiently high. Calculating an adjusted topic score allows for reasoned decisions regarding advertising placement and can optionally minimize the reliance on user-specific models. Calculating an adjusted topic score can allow for less granularity and more prudent estimation while potentially saving costs.

At 210, an action is taken with respect to advertising based on the adjusted topic score. In an example, the action is deciding whether or not to place an advertisement 219. In another example, the action is making a recommendation regarding whether or not to place an advertisement 221. The risk of offending a person in a given region by placing advertising regarding a given topic can be minimal if the person is in an area with high sentiment regarding that topic. This region can have a low, or nonexistent, penalty score. To illustrate, a user living in San Francisco—a region likely to have a relatively high adjusted topic score regarding the San Francisco Giants—a decision could be made to direct advertising for Giants merchandise to that user. Directing advertising for Giants merchandise can be prudent in this example because sentiment for the Giants in the region (San Francisco) is high. Accordingly, the risk of offending a user by showing them Giants merchandise is low.

Furthermore, users with low sentiment for a topic in a region of high sentiment for the topic are less likely to be offended by advertisements regarding the topic than users with low sentiment for the topic in regions with low sentiment for the topic. For example, a Los Angeles Dodger fan living in San Francisco may not be offended by advertisements regarding Giants merchandise perhaps because it is understandable to the user why he can be directed advertisements regarding Giants merchandise. The user can find it understandable because he lives in San Francisco: an area that the user can accept as likely to have high sentiment for the Giants.

Conversely, directing advertising regarding a given topic in a region bearing low sentiment regarding that topic can be imprudent. The risk of offending a person in a given region by placing advertising regarding a given topic can be enhanced if the person is in an area with low sentiment regarding that topic. This type of region can have a higher penalty score. To illustrate, a user living in San Francisco, a region likely to have a relatively low adjusted topic score regarding the Los Angeles Dodgers, a decision could be made not to direct advertising for Dodgers merchandise to that user. Not directing advertising to a user in a region with a low adjusted topic score about a topic can be prudent because the risk of offending a user by advertising the topic can be high. Offending a user or users is likely to have deleterious effects on the success of the advertising campaign.

Taking an action with respect to advertising can also include weighing the adjusted topic score relative to data specific to a user indicating that the sentiment of the user conflicts with the adjusted topic score 223. For example, a user in a region with high sentiment regarding a topic can still be offended by advertising regarding that topic. Here, if the user has supplied any data items indicating his low sentiment for the topic, the sentiment indicated in those data items could be weighed against the high adjusted topic score of the region. User-specific data items exhibiting sufficiently high weight could, for example, override an action with respect to advertising recommended by the adjusted topic score of the region. For example, an avid Dodger fan can live in San Francisco. If the fan, through data items obtained at 202, has indicated sufficiently low sentiment for the Giants and/or sufficiently high sentiment for the Dodgers, this user-specific data can override the general notion that the risk of offending a San Franciscan by presenting them with advertisements for the Giants is low.

FIG. 3 illustrates a block diagram 360 of an example of a computer-readable medium (CRM) 344 in communication with a computing device 318, e.g., Java application server, having processor resources of more or fewer than 320-1, 320-2 . . . 320-N, that can be in communication with, and/or receive a tangible non-transitory computer readable medium (CRM) 344 storing a set of computer readable instructions 324 executable by one or more of the processor resources (e.g., 320-1, 320-2 . . . 320-N) for estimating costs of behavioral targeting, as described herein. The computing device can include memory resources 322, and the processor resources 320-1, 320-2 . . . 320-N can be coupled to the memory resources 322.

Processor resources can execute computer-readable instructions 324 that are stored on an internal or external non-transitory computer-readable medium 344. A non-transitory computer-readable medium (e.g., computer readable medium 344), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), high definition digital versatile discs (HD DVD), compact discs (CD), and/or a solid state drive (SSD), flash memory, etc., as well as other types of machine-readable media.

The non-transitory computer-readable 344 medium can be integral, or communicatively coupled, to a computing device, in either in a wired or wireless manner. For example, the non-transitory computer-readable medium can be an internal memory, a portable memory, a portable disk, or a memory located internal to another computing resource (e.g., enabling the computer-readable instructions to be downloaded over the Internet).

The CRM 344 can be in communication with the processor resources (e.g., 320-1, 320-2 . . . 320-N) via a communication path 340. The communication path 340 can be local or remote to a machine associated with the processor resources 320-1, 320-2 . . . 320-N. Examples of a local communication path 340 can include an electronic bus internal to a machine such as a computer where the CRM 344 is one of volatile, non-volatile, fixed, and/or removable storage medium in communication with the processor resources (e.g., 320-1, 320-2 . . . 320-N) via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 340 can be such that the CRM 344 is remote from the processor resources (e.g., 320-1, 320-2 . . . 320-N) such as in the example of a network connection between the CRM 344 and the processor resources (e.g., 320-1, 320-2 . . . 320-N). That is, the communication path 340 can be a network connection. Examples of such a network connection can include a local area network (LAN), a wide area network (WAN), a personal area network (PAN), and the Internet, among others. In such examples, the CRM 344 can be associated with a first computing device and the processor resources (e.g., 320-1, 320-2 . . . 320-N) can be associated with a second computing device (e.g., a Java application server).

FIG. 4 illustrates a block diagram of an example of a computing system 490 for estimating costs of behavioral targeting according to the present disclosure. However, examples of the present disclosure are not limited to a particular computing system configuration. The system 490 can include processor resources 420 and memory resources (e.g., volatile memory 422 and/or non-volatile memory 438) for executing instructions stored in a tangible non-transitory medium (e.g., volatile memory 422, non-volatile memory 438, and/or computer-readable medium 444) and/or an application specific integrated circuit (ASIC) including logic configured to perform various examples of the present disclosure. The volatile memory 422 and the non-volatile memory 438 can be computer readable media. A computer (e.g., a computing device) can include and/or receive a tangible non-transitory computer-readable medium 444 storing a set of computer-readable instructions 424 (e.g., software) via an input device 442. As used herein, processor resources 420 can include one or a plurality of processors such as in a parallel processing system. Memory resources can include memory addressable by the processor resources 420 for execution of computer-readable instructions. The computer-readable medium 444 can include volatile and/or non-volatile memory such as random access memory (RAM), magnetic memory such as a hard disk, floppy disk, and/or tape memory, a solid state drive (SSD), flash memory, phase change memory, etc. In some examples, the non-volatile memory 438 can be a database including a plurality of physical non-volatile memory devices. In various examples, the database can be local to a particular system or remote (e.g., including a plurality of non-volatile memory devices 438). A computing device having processor resources can be in communication with, and/or receive a tangible non-transitory computer readable medium (CRM) 444 storing a set of computer readable instructions 424 (e.g., software) for estimating costs of behavioral targeting, as described herein.

The processor resources 420 can control the overall operation of the system 490. The processor resources 420 can be connected to a memory controller 436, which can read and/or write data from and/or to volatile memory 422 (e.g., RAM). The memory controller 436 can include an ASIC and/or a processor with its own memory resources (e.g., volatile and/or non-volatile memory). The volatile memory 422 can include one or a plurality of memory modules (e.g., chips).

The processor resources 420 can be connected to a bus 440 to provide for communication between the processor resources 420, and other portions of the system 390. The non-volatile memory 338 can provide persistent data storage for the system 490. The graphics controller 446 can connect to a user interface 448, which can provide an image to a user based on activities performed by the system 490.

Each system can include a computing device including control circuitry such as a processor, a state machine, application specific integrated circuit (ASIC), controller, and/or similar machine. As used herein, the indefinite articles “a” and/or “an” can indicate one or more than one of the named object. Thus, for example, “a processor” can include one processor or more than one processor, such as a parallel processing arrangement.

The control circuitry can have a structure that provides a given functionality, and/or execute computer-readable instructions that are stored on a non-transitory computer-readable medium (e.g. non-transitory computer-readable medium 444). The non-transitory computer-readable medium can be integral, or communicatively coupled, to a computing device, in either in a wired or wireless manner. For example, the non-transitory computer-readable medium 444 can be an internal memory, a portable memory, a portable disk, or a memory located internal to another computing resource (e.g., enabling the computer-readable instructions to be downloaded over the Internet). The non-transitory computer-readable medium 444 can have computer-readable instructions 424 stored thereon that are executed by the control circuitry (e.g., processor) to provide a particular functionality.

The non-transitory computer-readable medium, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), among others. The non-transitory computer-readable medium can include optical discs, digital video discs (DVD), Blu-Ray Discs, compact discs (CD), laser discs, and magnetic media such as tape drives, floppy discs, and hard drives, solid state media such as flash memory, EEPROM, phase change random access memory (PCRAM), as well as other types of computer-readable media.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed:

1. A computer-implemented method for estimating a cost of misclassification in a behavioral targeting model comprising:
scoring a topic with a behavioral targeting model;
obtaining a plurality of data items including geographic location information;
detecting and scoring a sentiment from filtered data items regarding a topic within a region;
computing a penalty score for the topic in the region in response to the scored sentiment exceeding a threshold;
adjusting the topic score in the region according to the penalty score; and
taking an action with respect to advertising based on the adjusted topic score.

2. The method of claim 1, wherein the method includes mapping the scored sentiment geographically by interpolating between the scored data items to fill the geographic mapping.

3. The method of claim 1, wherein the method includes interpolating between the scored data items to smooth the geographic mapping.

4. The method of claim 1, wherein the plurality of data items includes at least one of a social media message, a text message, a telephone call, an electronic mail message, a voicemail message, and an answering machine message.

5. The method of claim 1, wherein the method includes filtering the data items by topic according to metadata.

6. The method of claim 1, wherein the method includes filtering the data items by a region including at least one of monitoring IP addresses, monitoring cellular towers, monitoring content of a social media message, monitoring content of a text message, and monitoring global tracking on portable devices.

7. The method of claim 1, wherein detecting sentiment includes applying a sentiment dictionary to content of the plurality of data items.

8. The method of claim 7, wherein the method included adjusting the sentiment dictionary in response to changes in sentiment.

9. The method of claim 1, wherein taking an action with respect to advertising includes deciding whether or not to place an advertisement.

10. The method of claim 1, wherein taking an action with respect to advertising includes making a recommendation of whether or not to place an advertisement.

11. The method of claim 1, wherein taking an action with respect to advertising includes weighing the adjusted topic score relative to data specific to a user indicating that the sentiment of the user conflicts with the adjusted topic score.

12. A non-transitory computer-readable medium storing a set of instructions for estimating a cost of misclassification in a behavioral targeting model executable by the computer to cause the computer to:
score a topic with a behavioral targeting model;
obtain a plurality of data items including geographic location information;
filter the plurality of data items by a topic and a region;
detect a sentiment from the filtered data items regarding the topic within the region, wherein a sentiment dictionary is applied to the plurality of data items;
score the sentiment of the filtered data items regarding the topic in the region;
map the scored sentiment geographically, wherein interpolation is used to fill and smooth gaps in the geographic map of the scored sentiment;
compute a penalty score for the topic in the region in response to a scored sentiment that exceeds a threshold;
adjust the topic score in the region according to the penalty score; and
take an action with respect to advertising based on the adjusted topic score.

13. The computer-readable medium of claim 12, wherein the plurality of data items includes at least one of a social media message, a text message, a telephone call, an electronic mail message, a voicemail message, and an answering machine message.

14. The computer-readable medium of claim 12, wherein the plurality of data items are filtered by hashtags.

15. A system for estimating a cost of misclassification in a behavioral targeting model, the system having a processor and memory for storing executable instructions that are executable by the processor to:
score a topic with a behavioral targeting model;
obtain a plurality of data items including geographic location information;
filter the plurality of data items by a topic and a region according to hashtags;
detect a sentiment from the filtered data items regarding the topic within the region by use of a sentiment dictionary that can be adjusted to respond to changes in sentiment;
score the sentiment of the filtered data items regarding the topic in the region;
map the scored sentiment geographically, wherein interpolation is used to fill gaps in the geographic map of the scored sentiment;
compute a penalty score for the topic in the region in response to a scored sentiment that exceeds a threshold;
adjust the topic score in the region according to the penalty score; and
take an action with respect to advertising based on the adjusted topic score.
